(19) United States
(12) Patent Application Publication
(10) Pub. No.: US 2008/0019287 A1
(43) Pub. Date: Jan. 24, 2008

(54) Device discovery method, network device capable of performing the method, and storage medium thereof

(75) Inventor: Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/640,403

(22) Filed: Dec. 18, 2006

(30) Foreign Application Priority Data
Jul. 20, 2006 (KR) 10-2006-0068091

(51) Int. Cl. H04L 12/28; H04J 15/00

(52) U.S. Cl. 370/254; 370/464

(57) ABSTRACT

A device discovery apparatus and method for discovering a device in a plurality of channels in a service network using a beacon period are provided. The apparatus includes: a beacon period detection module which detects a beacon period by scanning one channel according to a scan order of the plurality of channels, and a transmission and reception module which transmits an announce request for device discovery to a network and performs device discovery with scanning at least one other channel according to a scan order of the plurality of channels.

### CROSS-REFERENCE TO RELATED PATENT APPLICATIONS

This application claims priority from Korean Patent Application No. 10-2006-0068091, filed on Jul. 20, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to device discovery in a service network, and more particularly, to a method of discovering a device (or a network device) in a plurality of channels in a service network, which performs an announce function by using a beacon period (BP), a network device capable of performing the method, and a storage medium therefor.

2. Description of the Related Art

The service network described above is a service network such as a consumer electronics (CE) service network operating in accord with WiMedia MAC/PHY. In the CE service network, a device (or a network device) is discovered using a beacon period. That is, in one beacon period, an announce request is transmitted to the CE service network and then, in the next beacon period, an announce response is received from the CE service network and thus the device (or the CE service network device) is discovered.

Accordingly, when a device in a plurality of channels is discovered, a conventional CE service network device (hereinafter referred to as a ‘device’) performs device discovery as illustrated in FIG. 1. FIG. 1 is a diagram of an example of a device discovery method performed in a conventional CE service network device. Here, scanning of channels is performed in the order of channel 1→channel 2→channel 3→and channel 4.

That is, in beacon period (1-1), the device transmits an announce request to the CE service network, and then, in beacon period (1-2), the device receives an announce response from the CE service network and thus discovers a device in channel 1.

After discovering the device in channel 1, in beacon period (2-2) of channel 2, the device transmits an announce request to the CE service network, and in beacon period (2-3), the device receives an announce response from the CE service network and thus discovers a device in channel 2.

After discovering the device in channel 2, in beacon period (3-3) of channel 3, the device transmits an announce request to the CE service network, and in beacon period (3-4), the device receives an announce response from the CE service network and thus discovers a device in channel 3.

After discovering the device in channel 3, in beacon period (4-4) of channel 4, the device transmits an announce request to the CE service network, and in beacon period (4-5), the device receives an announce response from the CE service network and thus discovers a device in channel 4.

Accordingly, in the case illustrated in FIG. 1, during a period corresponding to reference number 101, the device performs device discovery with respect to channel 1 and then, performs device discovery with respect to channel 2. During a period corresponding to reference number 102, the device performs device discovery with respect to channel 2 and then, performs device discovery with respect to channel 3. During a period corresponding to reference number 103, the device performs device discovery with respect to channel 3 and then, during a period corresponding to reference number 104, performs device discovery with respect to channel 4. Accordingly, in beacon period (4-5) of channel 4, the device discovery process with respect to channels 1 through 4 is finished.

FIG. 2 is a diagram of another example illustrating a device discovery method performed in a related art CE service network device. Here, scanning of channels is performed in the order of channel 1→channel 4→channel 3→and channel 2.

That is, in beacon period (1-1), the device transmits an announce request to the CE service network, and then, in beacon period (1-2), the device receives an announce response from the CE service network and thus discovers a device in channel 1.

After discovering the device in channel 1, in beacon period (4-2) of channel 4, the device transmits an announce request to the CE service network, and in beacon period (4-3), the device receives an announce response from the CE service network and thus discovers a device in channel 4.

After discovering the device in channel 4, in beacon period (3-4) of channel 3, the device transmits an announce request to the CE service network, and in beacon period (3-5), the device receives an announce response from the CE service network and thus discovers a device in channel 3.

After discovering the device in channel 3, in beacon period (2-6) of channel 2, the device transmits an announce request to the CE service network, and in beacon period (2-7), the device receives an announce response from the CE service network and thus discovers a device in channel 2.

Accordingly, in the case illustrated in FIG. 2, during a period corresponding to reference number 201, the device performs device discovery with respect to channel 1 and then, performs device discovery with respect to channel 4. During a period corresponding to reference number 202, the device performs device discovery with respect to channel 4 and then, performs device discovery with respect to channel 3. During a period corresponding to reference number 203, the device performs device discovery with respect to channel 3 and then, performs device discovery with respect to channel 2. During a period corresponding to reference number 204, the device performs device discovery with respect to channel 2. Accordingly, in beacon period (2-7) of channel 2, the device discovery process with respect to channels 1 through 4 is finished.

Thus, when the conventional CE service network device performs device discovery with respect to a plurality of channels, the conventional CE service network device cannot perform device discovery with respect to a channel until device discovery with respect to another channel is finished. Accordingly, with the increasing number of channels in which devices need to be discovered, the time required for discovering the devices increases.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, the present invention provides a device discovery method capable of quickly discovering devices in a plurality of channels in a service network using a beacon period, a network device performing the method, and a storage medium therefor.

According to an aspect of the present invention, there is provided a method of discovering devices in a plurality of channels, the method including: detecting a beacon period by scanning one channel according to a scan order of the plurality of channels; transmitting an announce request for device discovery, to a network if the beacon period is detected; and performing device discovery by scanning at least one other channel according to a scan order of the plurality of channels after transmitting the announce request.

The method may further include changing an object channel being scanned in order to receive an announce response to the announce request according to the scan order if it is determined that all the announce requests for device discovery in the plurality of channels are transmitted in the performing of the device discovering with respect to the at least one other channel.

The method may further include if it is time for a beacon period for receiving an announce response to be detected, while performing device discovery with respect to the at least one other channel, changing an object channel being scanned to a channel for receiving the announce response, receiving the announce response and collecting device information.

The method may further include if the device information is collected and the collected device information is not the device information of the last channel according to the scan order, changing the object channel being scanned to the channel which was being scanned before the announce response is received; and repeatedly performing the detecting of the beacon period, the transmitting of the announce request, the performing of device discovery with respect to the at least one other channel, and the collecting of the device information.

According to another aspect of the present invention, there is provided a network device performing a device discovery method, the device including a beacon period detection module detecting a beacon period by scanning a plurality of channels according to a scan order of the plurality of channels; a transmission and reception module transmitting to a network, an announce request for device discovery in a channel in which a beacon period is detected by the beacon period detection module, or receiving an announce response from the network; and a device information collection module, if the announce response is received through the transmission and reception module, parsing the received announce response and collecting device information of the channel corresponding to the announce response, wherein the beacon period detection module detects a beacon period for device discovery by scanning at least one other channel among the plurality of channels according to the scan order in a beacon period for an announce request of one channel among the plurality of channels and other than a beacon period for an announce response corresponding to the announce request.

### BRIEF DESCRIPTION OF THE DRAWINGS

The above and other features and aspects of the present invention will become more apparent by describing in detail exemplary embodiments thereof with reference to the attached drawings in which:

FIG. 1 is a diagram of an example illustrating a device discovery method performed in a conventional CE service network device;

FIG. 2 is a diagram of another example illustrating a device discovery method performed in a related art CE service network device;

FIG. 3 is a functional block diagram of a network device according to an exemplary embodiment of the present invention;

FIG. 4 is a diagram illustrating an example of a beacon period detected in a beacon period detection module illustrated in FIG. 3 according to an exemplary embodiment of the present invention;

FIG. 5 is a diagram illustrating another example of a beacon period detected in a beacon period detection module illustrated in FIG. 3 according to an exemplary embodiment of the present invention;

FIG. 6 is an operational flowchart illustrating a device discovery method according to an exemplary embodiment of the present invention; and

FIG. 7 is an operational flowchart illustrating a device discovery method according to another exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown.

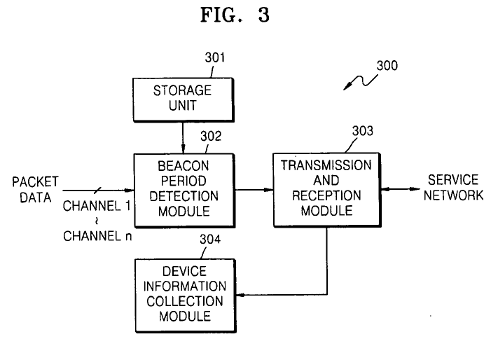

FIG. 3 is a functional block diagram of a network device according to an exemplary embodiment of the present invention. Referring to FIG. 3, the network device 300 includes a storage unit 301, a beacon period detection module 302, a transmission and reception module 303, and a device information collection module 304.

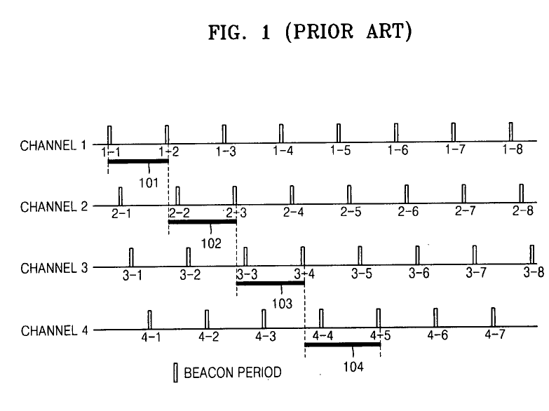

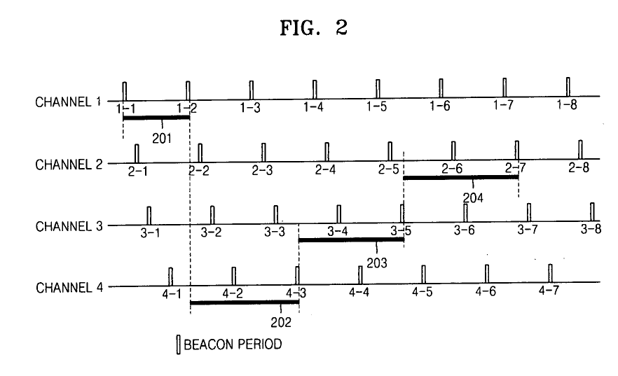

The storage unit 301 stores scan order information of a plurality of channels. For example, when device discovery is performed using 4 channels as illustrated in FIGS. 1 and 2, the scan order information of the 4 channels is stored in the storage unit 301. That is, in the case as illustrated in FIG. 1, scan order information with respect to the 4 channels, corresponding to channel 1→channel 2→channel 3→and channel 4, is stored in the storage unit 301. In the case as illustrated in FIG. 2, scan order information with respect to the 4 channels, corresponding to channel 1→channel 4→channel 3→and channel 2, is stored in the storage unit 301.

The beacon period detection module 302 detects a beacon period in packet data input through the plurality of channels (channels 1 through n), respectively, according to the scan order of the plurality of channels stored in the storage unit 301. If the plurality of channels is formed by channels 1 through 4, the channel n is channel 4. The packet data may be packet data transmitted in units of superframes.

According to the scan order information stored in the storage unit 301, the beacon period detection module 302 can scan at least one other channel among the plurality of channels in a period other than a beacon period for an announce request of one channel of the plurality of channels, and a beacon period for an announce response corresponding to the announce request. While scanning the at least one other channel, the beacon period detection module 302 detects a beacon period for device discovery.

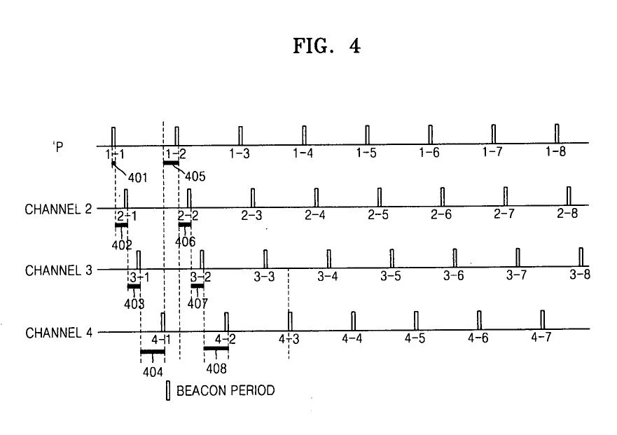

That is, according to the scan order of the plurality of channels, the beacon period detection module 302 can detect a beacon period as illustrated in FIG. 4. FIG. 4 is a diagram illustrating an example of a beacon period detected in the beacon period detection module 302 illustrated in FIG. 3 according to an exemplary embodiment of the present invention. Here, the scan order with respect to 4 channels is channel 1→channel 2→channel 3→and channel 4 as in FIG. 1.

Referring to FIG. 4, while scanning channel 1, if the beacon period detection module 302 detects a beacon period in channel 1 at a position indicated by reference number (1-1), the transmission and reception unit 303 transmits an announce request for device discovery in channel 1. According to the scan order, the beacon period detection module 302 changes the object channel of scanning from channel 1 to channel 2. Accordingly, during a period corresponding to reference number 401, the beacon period detection module 302 scans channel 1.

While scanning channel 2, if the beacon period detection module 302 detects a beacon period at a position indicated by reference number (2-1) illustrated in FIG. 4, the transmission and reception unit 303 transmits an announce request for device discovery in channel 2. According to the scan order, the beacon period detection module 302 changes the object channel of scanning from channel 2 to channel 3. Accordingly, during a period corresponding to reference number 402, the beacon period detection module 302 scans channel 2.

While scanning channel 3, if the beacon period detection module 302 detects a beacon period at a position indicated by reference number (3-1) illustrated in FIG. 4, the transmission and reception unit 303 transmits an announce request for device discovery in channel 3. According to the scan order, the beacon period detection module 302 changes the object channel of scanning from channel 3 to channel 4. Accordingly, during a period corresponding to reference number 403, the beacon period detection module 302 scans channel 3.

While scanning channel 4, if the beacon period detection module 302 detects a beacon period at a position indicated by reference number (4-1) illustrated in FIG. 4, the transmission and reception unit 303 transmits an announce request for device discovery in channel 4. At this time, after the beacon period is detected at the position (4-1) and all the announce requests for the 4 channels are transmitted, the object channel of scanning is changed from channel 4 to channel 1. In this case, channel 1 becomes the object channel of scanning for receiving an announce response to the announce request. Accordingly, during a period corresponding to reference number 404, the beacon period detection module 302 scans channel 4.

While scanning channel 1, if the beacon period detection module 302 detects a beacon period at a position indicated by reference number (1-2) illustrated in FIG. 4, the transmission and reception module 303 receives an announce response for the device discovery in channel 1. If the beacon period is detected at the position (1-2), the beacon period detection module 302 changes the object channel of scanning from channel 1 to channel 2. Accordingly, the beacon period detection module 302 scans channel 1 during a period corresponding to reference number 405.

While scanning channel 2, if the beacon period detection module 302 detects a beacon period at a position indicated by reference number (2-2) illustrated in FIG. 4, the transmission and reception module 303 receives an announce response for the device discovery in channel 1. If the beacon period is detected at the position (2-2), the beacon period detection module 302 changes the object channel of scanning from channel 2 to channel 3. Accordingly, the beacon period detection module 302 scans channel 2 during a period corresponding to reference number 406.

While scanning channel 3, if the beacon period detection module 302 detects a beacon period at a position indicated by reference number (3-2) illustrated in FIG. 4, the transmission and reception module 303 receives an announce response for the device discovery in channel 3. If the beacon period is detected at the position (3-2), the beacon period detection module 302 changes the object channel of scanning from channel 3 to channel 4. Accordingly, the beacon period detection module 302 scans channel 3 during a period corresponding to reference number 407.

While scanning channel 4, if the beacon period detection module 302 detects a beacon period at a position indicated by reference number (4-2) illustrated in FIG. 4, the transmission and reception module 303 receives an announce response for the device discovery in channel 4. If the beacon period is detected at the position (4-2), the beacon period detection module 302 finishes the beacon period detection operation for device discovery. Accordingly, the beacon period detection module 302 scans channel 4 during a period corresponding to reference number 408.

The device discovery with respect to the 4 channels finishes at the position (4-5) in the case illustrated in FIG. 1, while the device discovery finishes at the position (4-2) in the case illustrated in FIG. 4. Accordingly, it can be seen that when the device discovery is performed according to the current exemplary embodiment of the present invention, devices may be discovered faster compared to the conventional method. In addition, as illustrated in FIG. 4, when the device discovery with respect to the plurality of channels is performed, the announce requests for device discovery in all channels are transmitted before an announce response is received after the announce request for device discovery in channel 1 is transmitted. In this way, in a period for transmitting one superframe in channel 1, announce requests for all channels can be transmitted.

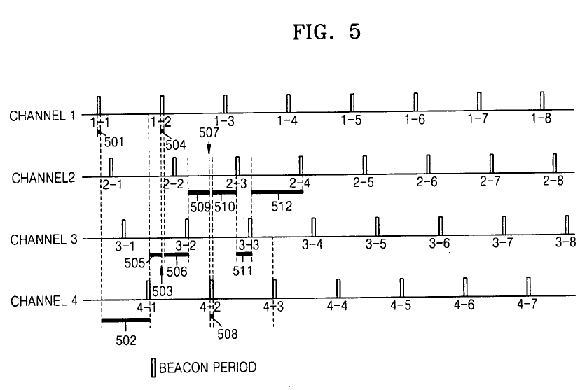

Meanwhile, when the scan order information stored in the storage unit 301 is defined as channel 1→channel 4→channel 3→and channel 2, the beacon period detection module 302 can detect a beacon period as illustrated in FIG. 5. FIG. 5 is a diagram illustrating another example of a beacon period detected in the beacon period detection module 302 illustrated in FIG. 3 according to an exemplary embodiment of the present invention. Here, the scan order with respect to 4 channels is channel 1→channel 4→channel 3→and channel 2 as in FIG. 2.

Referring to FIG. 5, while scanning channel 1, if the beacon period detection module 302 detects a beacon period in channel 1 at a position indicated by reference number (1-1), the transmission and reception unit 303 transmits an announce request for device discovery in channel 1. According to the scan order, the beacon period detection module 302 changes the object channel of scanning from channel 1 to channel 4. Accordingly, during a period corresponding to reference number 501, the beacon period detection module 302 scans channel 1.

While scanning channel 4, if the beacon period detection module 302 detects a beacon period at a position indicated by reference number (4-1) illustrated in FIG. 5, the transmission and reception unit 303 transmits an announce request for device discovery in channel 4. According to the scan order, the beacon period detection module 302 changes the object channel of scanning from channel 4 to channel 3. Accordingly, during a period corresponding to reference number 502, the beacon period detection module 302 scans channel 4.

While the beacon period detection module 302 scans channel 3, if it is time for a beacon period for receiving announce response of channel 1 to be detected, the beacon period detection module 302 changes the object channel of scanning from channel 3 to channel 1 at a position indicated by reference number 503. For this, after a beacon period in which an announce request is transmitted is detected in each channel, the beacon period detection module 302 can manage a time that a beacon period for receiving an announce response is received. Since a beacon period occurs periodically, the time can be set in advance.

After the object channel of scanning is changed to channel 1, if the beacon period detection module 302 detects a beacon period at a position indicated by reference number (1-2) illustrated in FIG. 5, the transmission and reception unit 303 receives an announce response for the device discovery in channel 1. If the beacon period is detected at the position (1-2), the beacon period detection module changes the object channel of scanning from channel 1 to channel 3, and continues channel scanning for device discovery in channel 3. As a result, during a period corresponding to reference number 504, the beacon period detection module 302 scans channel 1.

While scanning channel 3, if the beacon period detection module 302 detects a beacon period at a position indicated by reference number (3-2), the transmission and reception module 303 transmits an announce request for device discovery in channel 3. The beacon period detection module 302 changes the object channel of scanning from channel 3 to channel 2 according to the scan order. As a result, the beacon period detection module 302 scans channel 3 during a period corresponding to the sum of a period 505 and a period 506 (505+506).

While the beacon period detection module 302 scans channel 2, if it is time for a beacon period for receiving announce response of channel 4 to be detected, the beacon period detection module 302 changes the object channel of scanning from channel 2 to channel 4 at a position indicated by reference number 507. After the object channel of scanning is changed to channel 4, the beacon period detection module 302 receives an announce response for the device discovery in channel 4. If a beacon period is detected at the position (4-2) illustrated in FIG. 5, the beacon period detection module changes the object channel of scanning from channel 4 to channel 2, and continues channel scanning for device discovery in channel 2. As a result, during a period corresponding to reference number 508, the beacon period detection module 302 scans channel 4.

While scanning channel 2, if the beacon period detection module 302 detects a beacon period at a position indicated by reference number (2-3), the transmission and reception module 303 transmits an announce request for device discovery in channel 2. The beacon period detection module 302 changes the object channel of scanning from channel 2 to channel 3 according to the scan order. This is because the announce responses for device discovery in channels 1 and 4 have already been received, and the channels in which announce responses for device discovery have not been received are channel 2 and 3. As a result, the beacon period detection module 302 scans channel 2 during a period corresponding to the sum of a period 509 and a period 510 (509+510).

While scanning channel 3, if the beacon period detection module 302 detects a beacon period at a position indicated by reference number (3-3), the transmission and reception module 303 receives an announce response for the device operation in channel 3. If the beacon period is detected at the position (3-3), the beacon period detection module 302 changes the object channel of scanning from channel 3 to channel 2 and continues channel scanning for device discovery in channel 2. As a result, the beacon period detection module 302 scans channel 3 during a period corresponding to reference number 511.

While scanning channel 2, if the beacon period detection module 302 detects a beacon period at a position indicated by reference number (2-4) illustrated in FIG. 5, the transmission and reception module 303 receives an announce response for the device discovery in channel 2. As a result, the beacon period detection module scans channel 2 during a period corresponding to reference number 512. If the beacon period is detected at the position (2-4), the beacon period detection module 302 finishes the beacon period detection operation for device discovery.

The device discovery with respect to the 4 channels finishes at the position (2-7) in the case illustrated in FIG. 2, while the device discovery finishes at the position (2-4) in the case illustrated in FIG. 4. Accordingly, it can be seen that when the device discovery is performed according to the current exemplary embodiment of the present invention, devices may be discovered faster compared to the related art method.

The transmission and reception module 303 transmits to a service network, an announce request for device discovery in a channel in which a beacon period is detected by the beacon period detection unit 302, or receives an announce response from the service network.

If an announce response is received by the transmission and reception module 303, the device information collection module 304 parses the received announce response and collects device information of the channel corresponding to the announce response. In this way, the device information collection module 304 collects device information discovered in each channel.

The beacon period detection module 302 and the device information collection module 304 illustrated in FIG. 3 can be implemented to be included in a control module (not shown) controlling all functions of a network device.

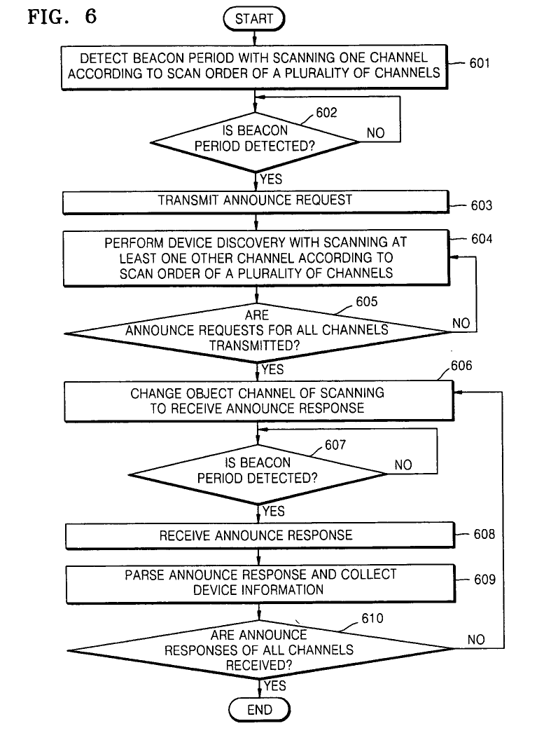

FIG. 6 is an operational flowchart illustrating a device discovery method according to an exemplary embodiment of the present invention.

Referring to FIG. 6, a device (or a network device) detects a beacon period with scanning one channel according to a scan order of a plurality of channels in operation 601. The one channel is the first scan channel of the plurality of channels. If a beacon period is detected in operation 602, the device transmits an announce request for device discovery in the first channel to a network in operation 603.

After transmitting the announce request, the device scans at least one other channel according to the scan order of the plurality of channels and thus performs device discovery in operation 604. That is, after the announce request in channel 1 is transmitted as illustrated in FIG. 4, announce requests in channel 2 through 4 can be transmitted in operation 604.

If announce requests for all channels are transmitted in operation 605, the device changes the object channel of scanning in order to receive an announce response according to the scan order in operation 606. That is, the network device changes the object channel of scanning to the first scan channel according to the scan order. In the case illustrated in FIG. 4, the object channel of scanning is changed to channel 1 in operation 606.

After the object channel of scanning is changed, if a beacon period is detected in operation 607, the device receives an announce response in operation 608, parses the received announce response, and thus collects discovered device information in operation 609. If announce responses in all channels are received, the device finishes the device discovery in operation 610. However, if announce responses in all channels are not received, operation 606 is performed and the process described above is repeated with changing the object channel of scanning.

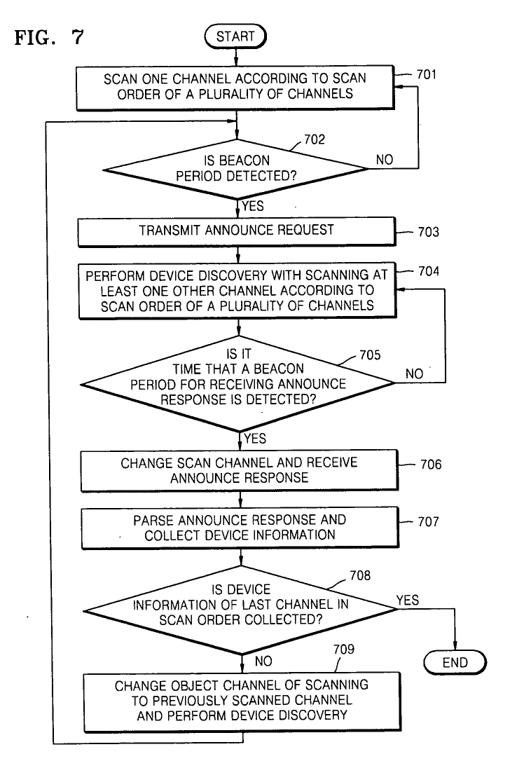

FIG. 7 is an operational flowchart illustrating a device discovery method according to another exemplary embodiment of the present invention.

Referring to FIG. 7, a device detects a beacon period by scanning one channel according to a scan order of a plurality of channels in operation 701. The one channel is the first scan channel of the plurality of channels. If a beacon period is detected in operation 702, the network device transmits an announce request for device discovery in the first channel to a network in operation 703.

After transmitting the announce request, the device scans at least one other channel according to the scan order of the plurality of channels and thus performs device discovery in operation 704. That is, after the announce request in channel 1 is transmitted as illustrated in FIG. 5, the device can transmit an announce request in channel 4 and scan channel 3 in operation 704.

While the device transmits an announce request for device discovery with scanning at least one other channel according to the scan order of the plurality of channels in operation 704, if it is time for a beacon period for receiving an announce response to the announce request transmitted in operation 703 to be detected in operation 705, the device changes the object channel of scanning to a channel in which the beacon period for receiving the announce response is detected, and receives the announce response in operation 706.

At this time, the object channel may be the first scanned channel. As described above with reference to FIG. 3, since a beacon period occurs periodically, a preset time can be used for the time that a beacon period for receiving an announce response is detected. That is, according to the preset time, the channel in which the beacon period for receiving an announce response is to be detected (for example, the first scan channel) can be returned as the object channel of scanning.

The device parses the received announce response and collects the discovered device information in operation 707. If the device information collected in operation 707 is not the device information of the last channel according to the scan order in operation 708, the device changes the object channel of scanning to the channel which was being scanned before the receiving of the announce response in operation 706, and performs device discovery in the channel in operation 709. Then, by repeatedly performing operation 702 through 708, the device discovery is performed as described above with reference to FIG. 5.

If the collected device information is the device information of the last channel according to the scan order in operation 708, the device finishes the device discovery.

According to the exemplary embodiments of the present invention, when a service network device in a plurality of channels is discovered using a beacon period, a service network device discovery in other channels is performed in a period other than a period for a beacon period for an announce request and a period for an announce response to the announce request. In this way, the service network device discovery in the plurality of channels can be performed quickly.

In particular, according to an exemplary embodiment, announce requests for device discovery in all channels may be transmitted in a period for transmitting one superframe, according to the scan order of the plurality of channels.

The method of discovering a network device according to the exemplary embodiment may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of discovering devices in a plurality of channels, the method comprising:
detecting a beacon period by scanning one channel based on a scan order of the plurality of channels;
transmitting an announce request for device discovery to a network if the beacon period is detected; and
performing device discovery by scanning at least one other channel based on the scan order of the plurality of channels after transmitting the announce request.

2. The method of claim 1, further comprising:
scanning one of the plurality of channels based on the scan order to receive an announce response to the announce request if it is determined that all the announce requests for device discovery in the plurality of channels are transmitted in the performing of the device discovering with respect to the at least one other channel.

3. The method of claim 2, further comprising receiving the announce response when a beacon period for receiving the announce response is detected in one of the plurality of channels, parsing the received announce response and collecting device information discovered in the one of the plurality of channels.

4. The method of claim 1, further comprising: scanning one of the plurality of channels to receive an announce response during a beacon period for receiving the announce response on the one of the plurality of channels, receiving the announce response and collecting device information.

5. The method of claim 4, further comprising:
scanning another one of the plurality of channels which was being scanned before the scanning to receive the announce response; and
performing, repeatedly, the detecting of the beacon period, the transmitting of the announce request, the performing of device discovery with respect to the at least one other channel, and the collecting of the device information.

6. A network device for performing device discovery, the device comprising:
a beacon period detection module which detects a beacon period by scanning a plurality of channels based on a scan order of the plurality of channels;
a transmission and reception module which transmits to a network, an announce request for device discovery in one of the plurality of channels in which a beacon period is detected by the beacon period detection module and receives an announce response from the network; and
a device information collection module which parses the received announce response and collects device information of the one of the plurality of channels corresponding to the announce response,
wherein the beacon period detection module detects another beacon period for device discovery by scanning at least another one of the plurality of channels based on the scan order during the beacon period for an announce request of the one of the plurality of channels.

7. The device of claim 6, wherein if beacon periods corresponding to announce requests for device discovery in the plurality of channels are detected, the transmission and reception module transmits to the network an announce response in one of the plurality of channels in which a beacon period is detected by the beacon period detection module.

8. The device of claim 7, wherein the scan order is set so that announce responses of the plurality of channels are received sequentially by channel.

9. The device of claim 6, wherein if it is time for a beacon period for receiving an announce response corresponding to the announce request to be detected, the beacon period detection module scans the one of the plurality of channels, and if the beacon period for receiving the announce response is detected, the transmission and reception module receives the announce response.

10. The device of claim 9, wherein if the announce response is received, the beacon period detection module scans the another one of the plurality of channels which was being scanned before the announce response was received.

11. A computer readable recording medium having embodied thereon a computer program for executing the method of discovering devices, wherein the method comprises:
detecting a beacon period by scanning one channel according to a scan order of a plurality of channels;
transmitting an announce request for device discovery, to a network if the beacon period is detected; and
performing device discovery by scanning at least one other channel according to a scan order of the plurality of channels after transmitting the announce request.
